(19) United States
(12) Patent Application Publication
(10) Pub. No.: US 2012/0181093 A1
(43) Pub. Date: Jul. 19, 2012

(54) MULTI-FLOW BULK WEIGHING SYSTEM

(75) Inventors: Dona M. Fehr, Paxton, IL (US); Paul Kaeb, Sabetha, KS (US); Dominic Meyer, Sabetha, KS (US)

(73) Assignee: KSI Conveyors, Inc., Cissna Park, IL (US)

(21) Appl. No.: 13/351,926

(22) Filed: Jan. 17, 2012

Related U.S. Application Data
(60) Provisional application No. 61/461,529, filed on Jan. 18, 2011.

(51) Int. Cl. G01G 13/24

(52) U.S. Cl. 177/103

(57) ABSTRACT

An arrangement for weighing bulk materials includes plural hoppers each having its own weighing system for accurately determining material discharge rate (lbs/minute) and for directing the contents of the hoppers to a product processing stage either sequentially from one hopper at a time while the other hoppers are being re-filled to provide continuous, non-stop operation, or in the alternative, from two or more hoppers simultaneously for blending the materials under the precise control of a programmed controller. Material discharge rate from each hopper is determined by continuous weighing of each hopper and its contents and is controlled in real time by precise computer controlled positioning of each hopper's slide gate. In the blending mode of operation, accurate monitoring of the material discharge rate is coordinated with processing of the material in a subsequent processing stage to allow for variation of the discharge rate to precisely match the subsequent processing parameters.

### FIELD OF THE INVENTION

This invention is directed to the handling of large volumes of materials in bulk form and is particularly directed to the measurement and control of either the simultaneous or the sequential discharge rate of bulk materials, such as crop seeds, from plural hoppers.

### BACKGROUND OF THE INVENTION

Bulk materials, such as crop seeds, are typically stored in elevated hoppers from which the material is discharged for distribution or use. Accuracy in the discharge of the material from its hopper is obviously desirable, particularly when dealing with valuable bulk materials. Accuracy and the metering of bulk material discharge is particularly important when the contents of two or more hoppers are combined to provide a mixture having a designated composition. In the case of crop seeds, the importance of accurate crop seed discharge from plural hoppers is of increased importance because the discharged seeds frequently undergo additional processing such as in the application of various nutrients, inoculants, fungicides, and pesticides prior to planting. Under application of any of these treatments to too large a volume of seed, or over application of treatment to too small a volume of seed arising from errors in the amount of seed discharged to the treatment stage can substantially reduce the size and value of the crop produced by the seeds.

In the past, seed discharge monitoring and control has involved weighing a sample of a known volume of the seed to provide the weight of the seed for a given volume and thus its density. This density value is then used to calibrate the seed discharge metering control system. However, this value depends upon the size of the individual seeds, i.e., seeds smaller in size have a larger density value for a given volume then larger seeds. This source of seed metering inaccuracy has plagued crop seed distribution systems and networks at great expense to individual participants.

The present invention is intended to overcome the problems of the prior art by providing for the accurate metering of the discharge, or release, of virtually any bulk material, but particularly with respect to crop seeds, from storage hoppers for subsequent distribution, processing or use. This invention is intended for use with plural hoppers wherein the crop seeds may be discharged either sequentially from one hopper at a time such as in batch processing, or in the alternative from two or more hoppers simultaneously as in the blending of seeds.

### OBJECTS AND SUMMARY OF THE INVENTION

Accordingly, it is an object of the present invention to provide for the monitoring and precise control of the discharge of bulk materials from plural hoppers holding the materials.

It is another object of the present invention to provide a continuous operation batch weighing system using plural bulk material hoppers wherein bulk material is discharged from a first hopper while one or more second hoppers are being re-filled, with discharge from one of the second hoppers initiated precisely when the first hopper is emptied with the sequence continuing seamlessly without interruption.

Yet another object of the present invention is to provide for the accurate treatment of a bulk material, such as crop seeds, by closely monitoring the weight of the bulk material to precisely determine and control the discharge rate of the material so as to match the prescribed criteria of the treatment process.

A further object of the present invention is to provide for the precise prescribed blending of crop seeds to form a mixture by continuously measuring the weight of the seeds discharged from each of the plural hoppers forming the mixture and independently, simultaneously and precisely controlling the seed discharge rate from each of the hoppers to provide the prescribed blend.

A still further object of the present invention is to precisely control the rate of discharge of a bulk material, such as crop seeds, from a hopper containing the bulk material by continuously monitoring the position of the hopper's discharge slide gate and positioning the slide gate using a feedback control system including an air cylinder to an accuracy of +/−1% of full stroke, or to within +/−0.001 inch.

The present invention contemplates an apparatus for controlling the discharge of bulk material from plural hoppers, said apparatus comprising plural gates each attached to a lower portion of and disposed over an aperture in a respective hopper and movable in a substantially continuous manner between a closed position and a full open position; plural scales attached to each of said hoppers for weighing each of said hoppers and the bulk material within the hopper and measuring the rate of seed discharge of the bulk material from each of the hoppers; and a controller coupled to each of said gates and to each of said scales for positioning each gate in a respective hopper in a designated position so as to provide a predetermined discharge rate of the bulk material.

### BRIEF DESCRIPTION OF THE DRAWINGS

The appended claims set forth those novel features which characterize the invention. However, the invention itself, as well as further objects and advantages thereof, will best be understood with reference to the following detailed description of a preferred embodiment taken in conjunction with the accompanying drawings, where like reference characters identify like elements throughout the various figures, in which:

FIGS. 1, 2 and 3 are respectively upper perspective, front elevation and side elevation views of a multi-flow bulk weighing system in accordance with the present invention;

FIG. 4 is a perspective view of an embodiment of a seed metering arrangement for use in the multi-flow bulk weighing system of the present invention;

FIG. 5 is a lateral elevation view shown partially in phantom of the multi-flow bulk weighing system of the present invention;

FIGS. 7-13 are graphic illustrations of the performance of the inventive multi-flow bulk weighing system of the present invention; and

FIGS. 14a and 14b are flow charts illustrating the sequence of operations carried by the multi-flow bulk weighing system of the present invention under the control of its master controller.

### DETAILED DESCRIPTION OF THE PREFERRED EMBODIMENTS

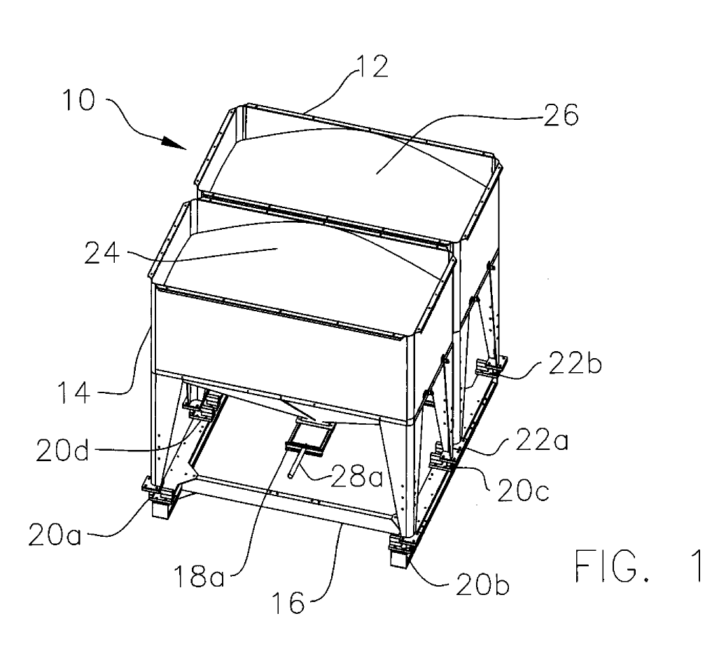

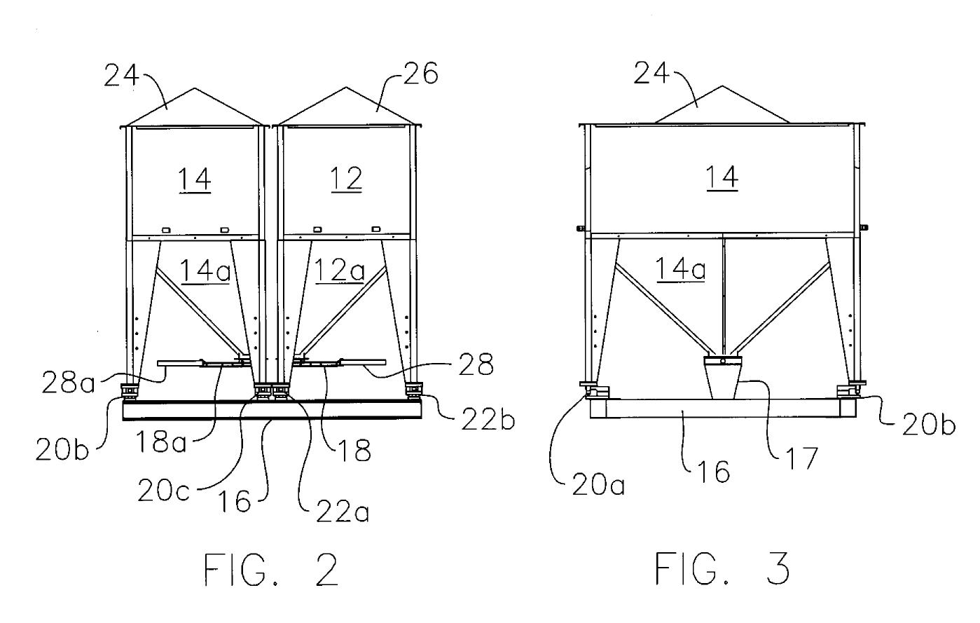

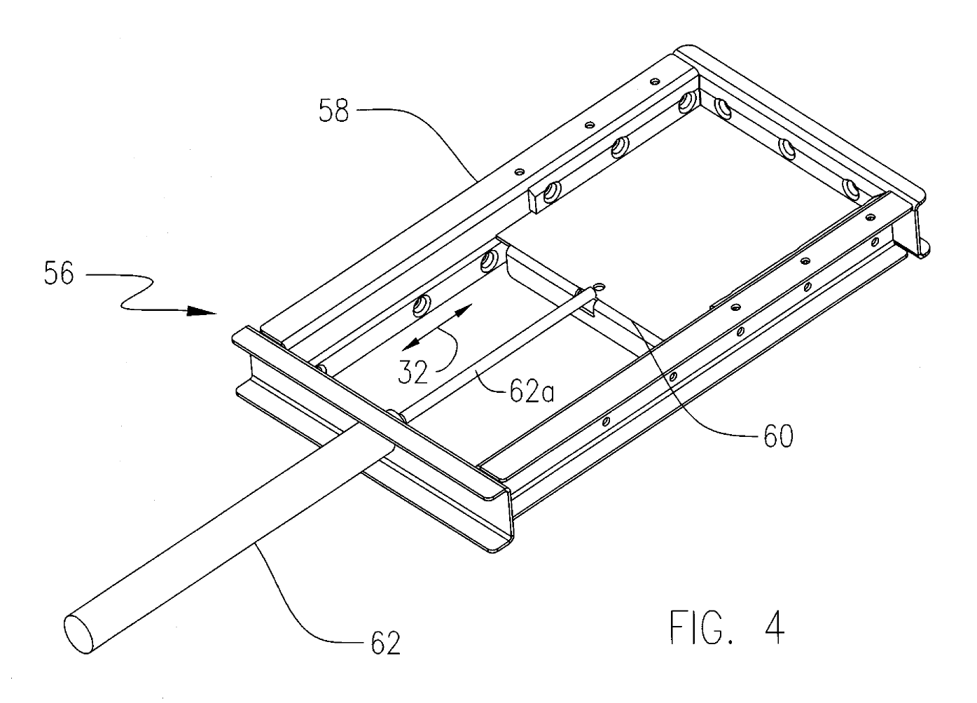

Referring to FIGS. 1-3, there are respectively shown upper perspective, front elevation and side elevation views of a multi-flow bulk weighing system 10 in accordance with the present invention. Bulk weighing system 10 includes first and second hoppers 12 and 14 respectively holding first and second bulk materials 24 and 26. While the present invention is disclosed primarily in terms of the bulk materials 24, 26 being seeds, the bulk weighing system 10 of the present invention may be used with virtually any type of bulk material i.e., a large mass, or volume, of particulate material.

Each of the first and second hoppers 12, 14 is positioned upon and supported by plural legs. A lower end of each of the legs is positioned upon and supported by a respective weigh cell, or beam scale. Thus, the lower end of the legs supporting the first hopper 12 are disposed upon respective first weigh cells 22a-22b, while the four support legs of the second hopper 14 are each disposed upon a respective one of second weigh cells, which are identified as elements 20a-20d in the figures. Each of the aforementioned weigh cells is disposed on a lower sub-frame 16 which provides support for the first and second hoppers 12, 14.

Each of the first and second hoppers 12, 14 includes a respective lower tapered discharge portion 12a and 14a for directing the material from the first and second hoppers to a lower discharge housing 17. Attached to discharge housing 17 are first and second hopper gates 18 and 18a for respectively discharging material from the first and second hoppers 12, 14. Thus, when the first hopper gate 18 is opened, material is discharged from the first hopper 12 via first discharge housing 12a. Similarly, when the second hopper gate 18a is opened, material is discharged from the second hopper 14 via second discharge housing 14a. The opening and closing of the first and second hopper gates 18, 18a is controlled by first and second pneumatic control cylinders 28 and 28a, respectively. Control of the first and second hopper gates 18, 18a may be provided by means other than pneumatic cylinders, however, the use of pneumatic cylinders is preferred because of the precise and rapid control of the positions of the hopper gates available with the use of pneumatic cylinders. A pneumatic pressure source is coupled to each of the first and second control cylinders 28, 28a to provide for simultaneous, independent control of each of the gates, although the pneumatic pressure source is not shown in the figures for simplicity.

Bulk material is discharged from the first and second hoppers 12, 14 either simultaneously from both of the hoppers, or alternately in a sequential manner from each of the hoppers. Simultaneous discharge of the bulk material from both of the first and second hoppers 12, 14 allows for precise blending of the material simultaneously discharged from the first and second hoppers. Alternating discharge from the first and second hoppers 12, 14 allows for sequential discharge of contents from the first and second hoppers to permit one hopper to be refilled after it is emptied while the other hopper is discharging its bulk material. This eliminates hopper “down time” for efficient discharge of the bulk material without interruption. Additional details of the manner of carrying out a preferred embodiment of the present invention are provided below. In addition, while the present invention is described as including two hoppers, the present invention is not limited to this number of hoppers, but may use virtually any number of hoppers connected to a common discharge housing for precisely regulating the flow of bulk material from all of the hoppers, either simultaneously, or alternately in a sequential manner.

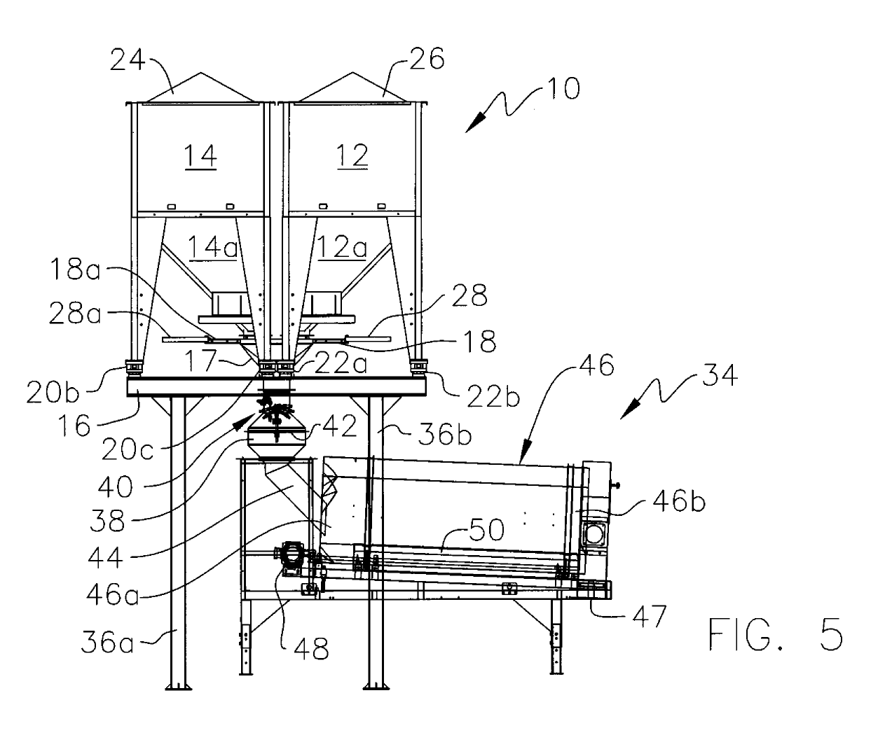

Referring to FIG. 4, there is shown a perspective view of a seed metering arrangement 56 in accordance with one embodiment of the present invention. Seed metering arrangement 56 includes a generally rectangular frame 58 in which is disposed in a movable manner a slide gate 60. Frame 58 limits the movement of slide gate 60 to the generally planar configuration of the frame. Attached to one end of frame 58 is a pneumatic cylinder 62 having an extendible arm 62a coupled to slide gate 60 which allows for the movement of the slide gate in the directions of arrow 32 for opening and closing the hopper (not shown) to which the seed metering arrangement is connected.

Referring to FIG. 5, there is shown a side elevation view of the multi-flow bulk weighing system 10 described above used in combination with a seed treatment system 34. In FIG. 5, the multi-flow bulk weighing system 10 is provided with the same element identifying numbers as used in FIGS. 1-3.

In FIG. 5, the first and second hoppers 12,14 are positioned on and supported by plural support members which include first and second, generally vertical support members 36a and 36b. Connected to sub-frame 16 and disposed below the discharge housings 12a and 14a of the first and second hoppers 12, 14 is the combination of a discharge housing 17 and a treatment head, or spray housing, 38 within which is disposed a nozzle assembly 40. Treatment head 38 is adapted to receive bulk material, such as crop seeds, discharged under the influence of gravity from the discharge housings 12a and 14a. Disposed in, or adjacent, to an upper portion of treatment head 38 is nozzle assembly 40 which is adapted to spray one or more chemicals on the falling seeds as they pass downward through the treatment head 38. Disposed within treatment head 38 is an atomizing arrangement, such as in the form of a flat, apertured plate 42 disposed below and rotationally displaced with nozzle assembly 40. The chemical, or chemicals, discharged from the nozzle assembly 40 is reduced to small droplets by atomizing plate 42 to produce a fine mist for covering the outer surface of the seeds transiting treatment head 38. The downward falling seeds are directed from treatment head 38 to a discharge chute 44 which directs the seeds into another portion of the seed treatment system 34.

As the seeds exit discharge chute 44, they are deposited in a first end 46a of a rotary drum 46 of the seed treatment system 34. Rotary drum 46 is generally cylindrical in shape and is rotated by means of a rotary drive 48. Disposed on an inner surface of rotary drum 46 are multiple ribs, or paddles, 50 which extend substantially the length of the rotary drum and engage and agitate the crop seed deposited within the rotary drum to reduce clumping of the seeds, provide uniform coverage of treatment on the seeds, and increase mixing of the seeds where different types of seeds are deposited by the first and second hoppers 12, 14 to provide a composite seed mixture within rotary drum 46. Rotary drum 46 is maintained in an inclined orientation such that its inlet end 46a is disposed above its outlet end 46b. This inclined orientation of rotary drum 46 allows the seeds within the rotary drum to be discharged from an aperture 47 in its discharge end 46b by the action of inner ribs 50 on the seeds.

Referring to FIG. 6, there is shown a combined schematic and block diagram of the multi-flow bulk weighing system 10 of the present invention. As described above, the bulk weighing system 10 includes first and second hoppers 12, 14. Respectively coupled to first and second hoppers 12, 14 are the combination of the first hopper gate 18 and first control cylinder 28, and the second hopper gate 18a and the second control cylinder 28a. Also as described above plural weigh cells are attached to lower portions of each of the first and second hoppers 12, 14, with weigh cell 22b coupled to the first hopper and weigh cell 20b coupled to the second hopper as shown in FIG. 6.

Bulk weighing system 10 further includes a master controller 80 having a touch screen 80a as well as first and second NTEP scales 72 and 74. Scale data is sent to the master controller 80 from the first and second NTEP scales 72, 74, and various commands are output from the master controller to the two scales. The first and second NTEP scales 72, 74 are respectively coupled to the load cells 22b of the first seed hopper 12 and to the load cells 20b of the second seed hopper 14 by respective plural cables.

Bulk weighing system 10 further includes first and second hopper variable weight controllers 76 and 78. First and second hopper controllers 76, 78 are also coupled to master controller 80 and receive various control inputs from the master controller. The first hopper controller 76 is coupled to and provides controlled air to first control cylinder 28a for precisely controlling the position of the first hopper gate 18 connected thereto. Similarly, the second hopper controller 78 is coupled to and provides controlled air to second control cylinder 28a for precisely controlling the open/close position of the second hopper gate 18a connected thereto. Each of the first and second hopper controllers 76, 78 is also responsive to cylinder position feedback signals respectively received from the first and second control cylinders 28, 28a. Each of the first and second NTEP scales 72, 74 provides for the capability of filling its associated hopper with seed product to a designated, or predetermined, target weight. Each of the scales 72, 74 further measures the rate of weight change of its associated hopper with the filling and/or discharging of seed to/from the hopper using the hopper's weigh cells which provide appropriate signals to each of the scales. The rate of change value in discharging seed from each scale is used by the master controller 80 to precisely adjust the position of each of the first and second hopper gates 18, 18a to maintain a predetermined rate of discharge of the seed. The seed discharge rate of change value is also used with the seed treatment system 34 for controlling the treatment of the seed at a designated proportional rate.

The flexibility of the bulk weighing system 10 of the present invention allows for precise control of seed discharge for various types of seed processing and operations. For example, the bulk weighing system 10 may discharge the seed in an uninterrupted flow from plural hoppers to downstream treatment devices by sequentially and rapidly switching among various seed hoppers, with only one hopper discharging seed at a given time and the remaining hoppers being refilled during that same period. This uninterrupted flow of product provides for efficient use of the plural hoppers in reducing the time for off loading large quantities of seed. The bulk weighing system 10 is further capable of operation in a staging mode, wherein a first order for seed is carried out using one hopper, while continuing to process additional orders through other available hoppers. Queuing operation is also available using the bulk weighing system 10 of the present invention, wherein multiple orders are initialized in a control queue such that each order in queue is processed automatically as soon as previous orders are filled and a given filled hopper becomes available. Finally, the blending of seed is also possible using the bulk weighing system 10 of the present invention by loading different seed products in different hoppers, and discharging the hoppers simultaneously each at a predetermined, controlled discharge rate for providing a composite output product having a precisely controlled seed blend ratio.

The multi-flow bulk weighing system 10 of the present invention operates in the following manner to precisely control seed discharge flow rate as well as the treatment, or application, of various chemicals to the seed in a downstream bulk seed treatment system 34 as previously described. The following discussion covers the actual performance of the inventive multi-flow bulk weighing system 10 during operational testing.

Master controller 80 functions as a programmable automation controller in exercising control over the bulk weighing system 10 in accordance with inputs provided by a system operator. Master controller 80 includes programming for interfacing with the operator, monitoring and controlling the flow of seed from the various hoppers, and monitoring and controlling the flow of treatment chemicals applied to the seed downstream from where the seed is discharged from the hoppers. Each of the NTEP scales 72, 74 is a Legal Trade Scale which is used to weigh the seed and to also determine the rate of seed flow from each of the respective hoppers to the seed treatment system 34. As such, each scale hopper is preferably situated directly above the head of the seed treatment system 34. The first and second hopper gates 18, 18a are precisely positioned by means of a respective continuous position feedback air cylinder 28, 28a, which provides gate position accuracy of +/−1% of full cylinder stroke and can repeatedly be repositioned to the same position within +/−0.01 inch.

The operator inputs via the touch screen 80a of the master controller 80 the various system operating parameters such as seed hopper source, seed batch size, and seed flow rate through the seed treatment system 34 (lbs/min) following discharge from one of the various hoppers, and the treatment application ratio (oz/cwt) for one or more treatment chemicals, or liquids, located in individual tank/pump/flow meter packs. The bulk weighing system 10 provides seed from the appropriate hopper, delivering the requested quantity of seed to the scale hopper in readying the system for the treatment phase.

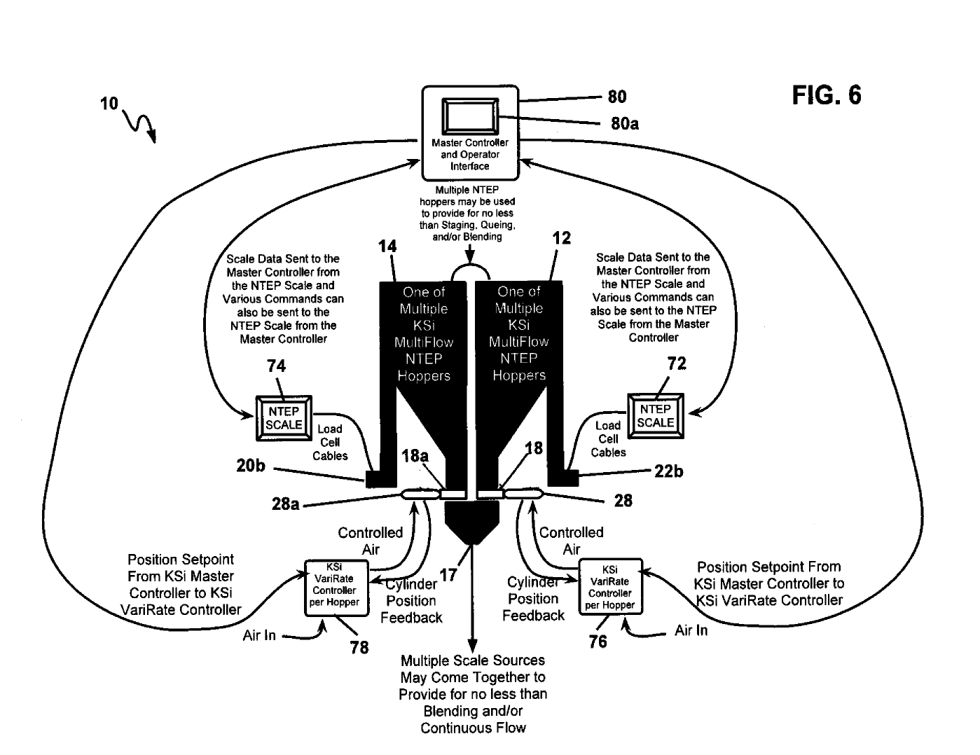

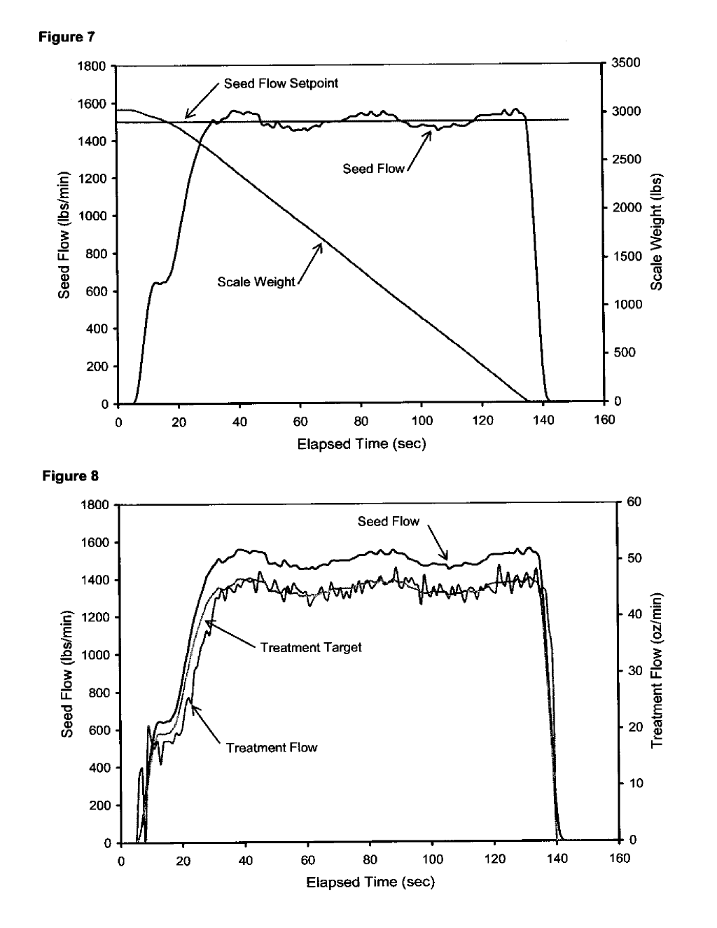

During the treatment phase, master controller 80 monitors the rate of change on the scale as seed flows from a scale hopper into the treatment head 38 during the treatment cycle. The scale weight is sampled 10 times per second and the scale discharge rate (in lbs/min) is continuously calculated by the master controller 80 as shown in the graphic representation of FIG. 7. Master controller 80 compares the scale discharge rate to the requested seed flow rate and adjusts the hopper slide gate accordingly to provide the desired seed flow rate.

At a rate of 10 times per second, the master controller 80 also adjusts the treatment flow rate (oz/min) to appropriately proportion treatment of the seed. Using the seed flow rate calculation, master controller 80 determines the required treatment flow rate (oz/min) based on the specified treatment application rate (oz/cwt) as shown in FIG. 8. Master controller 80 then adjusts the pump speed of the treatment liquid source based on the flow meter feed back to deliver the required liquid treatment application rate to the seed treatment system 34 also as shown in FIG. 8.

The bulk weighing system 10 was operated as designed and measurements were made of its performance. A total batch quantity of approximately 3000 lbs of soybean seed was placed on a scale hopper and the weight was recorded. Seed flow checkpoints were varied from 1500 lbs/min to 3000 lbs/min. A constant treatment target of 3 oz/cwt was maintained for all tests. The tests were started via the touch screen panel 80a of master controller 80. Seed flowed from a scale hopper to a seed conveyor to a second hopper. Data was logged 1 time per second for the entire length of the test. A seed treatment pump was set so that the treatment material (water) would be captured in a calibration tube. The total ounces of treatment water in the calibration tube was recorded at the conclusion of each test for comparison to the total calculated by the operating program of the bulk weighing system 10. Test accuracy was calculated by dividing the ounces of treatment water by the ounces of treatment required. Ounces of treatment required was calculated by multiplying the treatment application rate (oz/cwt) by the total quantity of seed.

The results of the tests of the bulk weighing system 10 discussed above are summarized in Table 1. All tests used a total seed quantity of approximately 3000 lbs. The length of test was therefore shorter for higher seed flow rates. The treatment volume determined by the totalizer closely matched the treatment volume collected in the calibration tube. Treatment accuracy for tests 1201 through 1204 shown in Table 1 simulating standard operation ranged from 98.1% to 98.9%.

TABLE 1

| | Start | End | | Seed | | | | | |
|---|---|---|---|---|---|---|---|---|---|
| | Scale | Scale | Total | Rate | Length | Treatment | Treatment | Treatment | |
| Test | Wt | Wt | Seed | SP | of Test | Required | Totalizer | Applied | |
| No. | (lbs) | (lbs) | (lbs) | (lbs/min) | (sec) | (oz) | (oz) | (oz) | Accuracy |
| 1201 | 3045 | 5 | 3040 | 1500 | 141 | 91.2 | 89.8 | 89.8 | 98.5% |
| 1202 | 3075 | 5 | 3070 | 2000 | 111 | 92.1 | 90.9 | 91.1 | 98.9% |
| 1203 | 3120 | 0 | 3120 | 2500 | 92 | 93.6 | 91.9 | 92.2 | 98.5% |
| 1204 | 3130 | 0 | 3130 | 3000 | 75 | 93.9 | 91.2 | 92.1 | 98.1% |

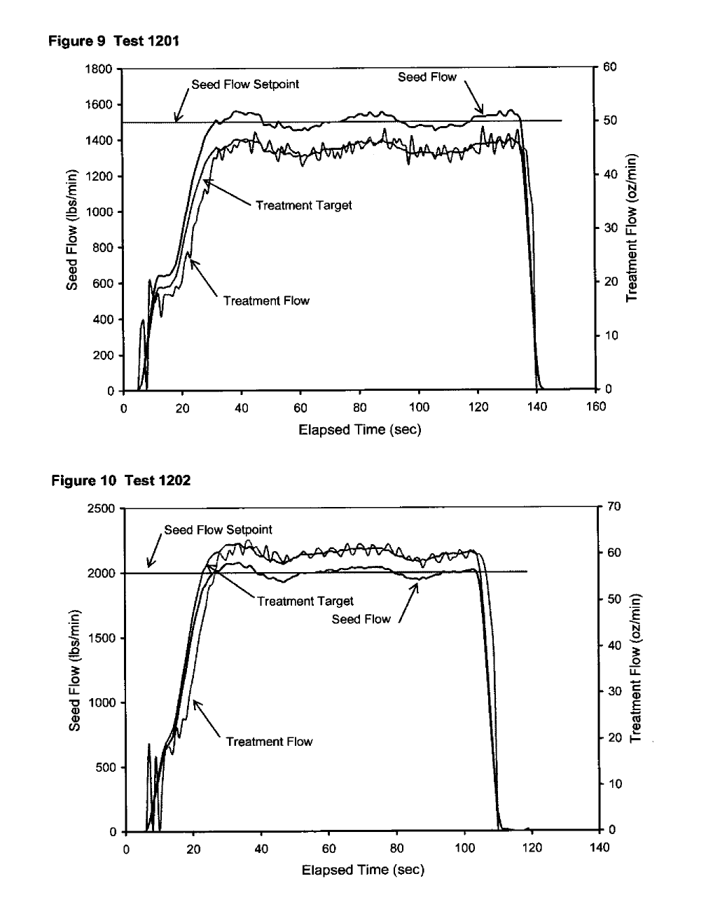

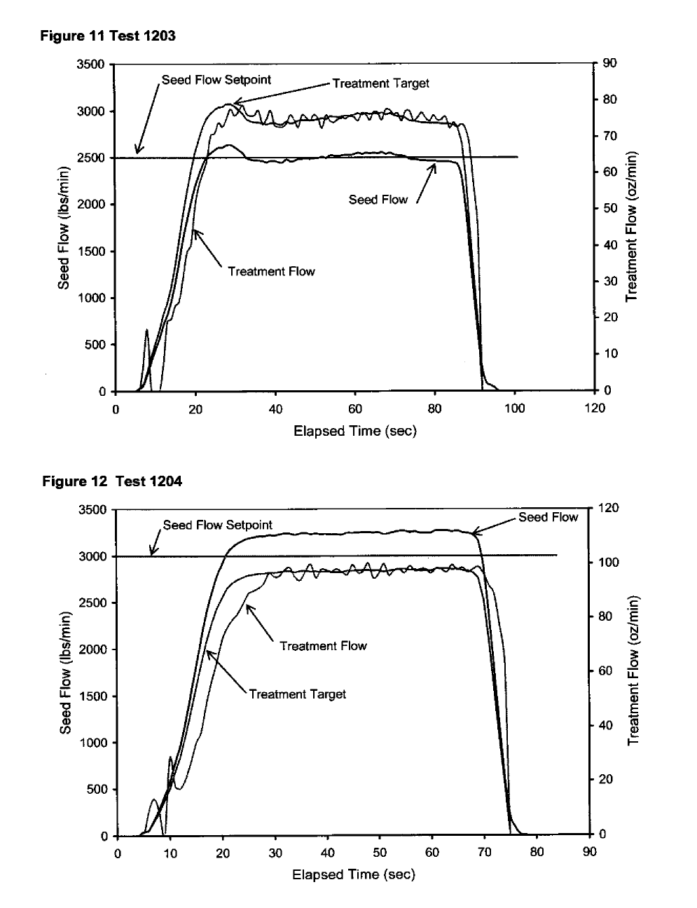

A graphic representation of the yield-time seed flow set point, seed flow rate, treatment flow target, and treatment flow rate is shown for each standard operation test in FIGS. 9-12. These figures illustrate that while the seed flow rate does not exactly match the setpoint, the treatment target flow rate follows closely the actual seed flow rate. In turn, the treatment flow rate closely follows the treatment target flow rate in these figures.

An additional test (1207) was conducted to determine the robustness of the bulk weighing system 10 control scheme in responding to process upsets. In this test, the flow of seed exiting the scale hopper was momentarily restricted, and suddenly released to determine how the system would respond to unexpected changes in seed flow. This test simulates the system's response to factors that could cause unexpected changes to seed flow rate such as build-up in the seed treatment head, differences in seed flow characteristics, varying seed count, etc. Data was logged and tabulated in the same way as for the others tests discussed above. The summary of the test is shown in Table 2. This relatively severe process upset resulted in an over-application of 3.1% of treatment material.

TABLE 2

| | Start | End | | Seed | | | | | |
|---|---|---|---|---|---|---|---|---|---|
| | Scale | Scale | Total | Rate | Length | Treatment | Treatment | Treatment | |
| Test | Wt | Wt | Seed | SP | of Test | Required | Totalizer | Applied | |
| No. | (lbs) | (lbs) | (lbs) | (lbs/min) | (sec) | (oz) | (oz) | (oz) | Accuracy |
| 1207 | 3135 | 5 | 3130 | 1500 | 148 | 93.9 | 98.7 | 96.8 | 103.1% |

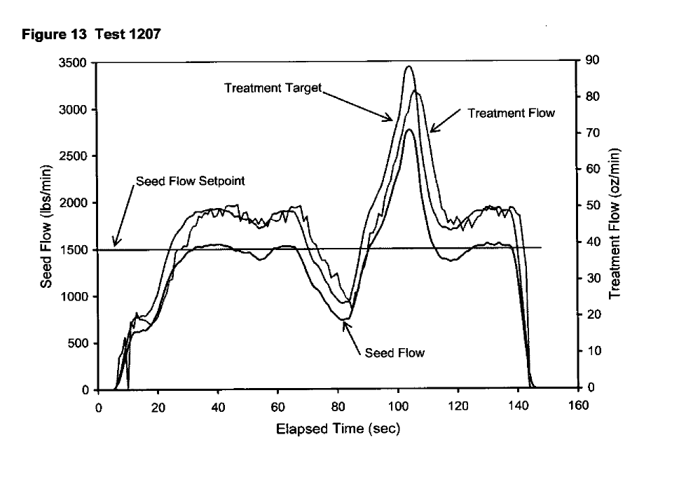

The graphic representation of the real time data for process upset conditions is shown in FIG. 13. In this figure, it can be seen that even under conditions of relatively severe process upset, the bulk weighing system 10 of the present invention causes the treatment flow to closely match the seed flow, even if the seed flow rate is varying significantly.

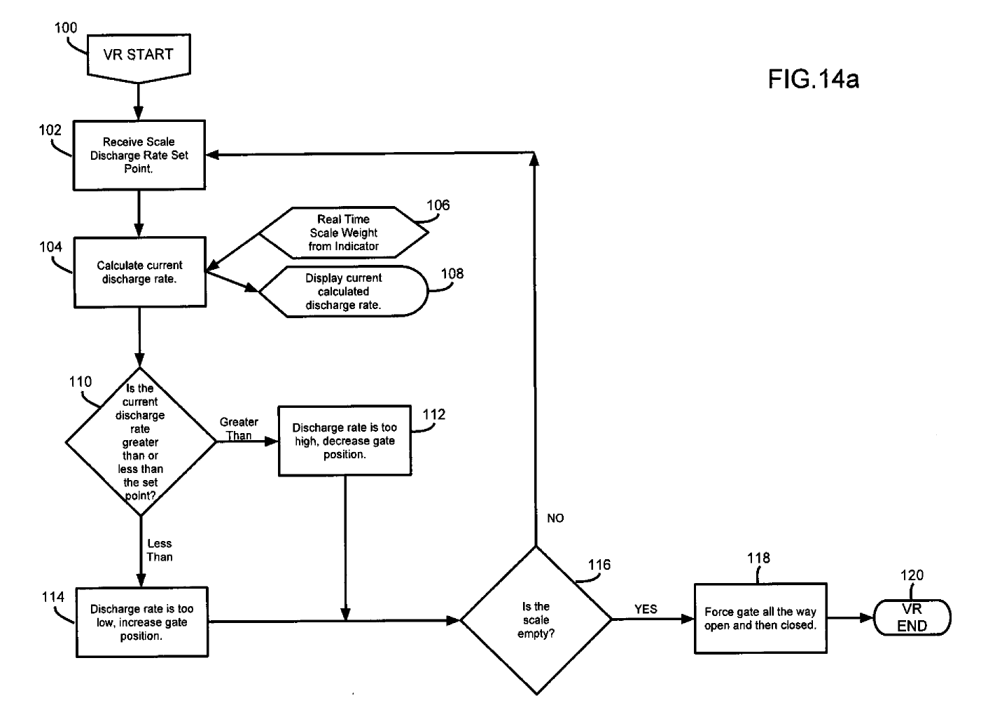

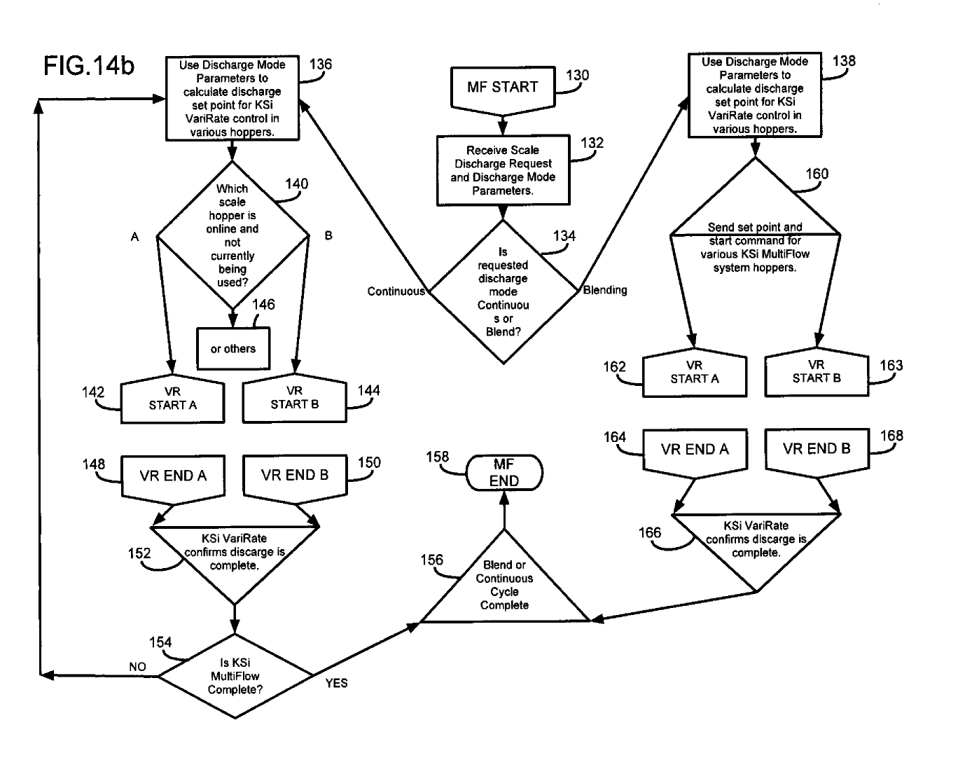

Referring to FIGS. 14a and 14b there are shown the series of steps carried out by the multi-flow bulk weighing system 10 of the present invention under the control of its master controller 80 for controlling seed discharge from a hopper, and for controlling the sequential discharge from multiple hoppers or the simultaneous discharge from two or more hoppers, respectively. The exercise of control of the master controller 80 over seed discharge from a hopper starts at step 100 in FIG. 14a. A program in master controller 80 then proceeds to step 102 for receiving the scale discharge rate set point 105 as entered by an operator. The program then proceeds to step 104 and calculates the current discharge rate based upon the rate of change of the weight of the hopper and its seed content as measured by its weight scales at step 106. The system then displays the current calculated discharge rate at step 108. After calculating and displaying the current discharge rate, the program proceeds to step 110 to determine if the current discharge rate is greater than or less than the set point. If it is determined that the discharge rate is greater than the set point, the program proceeds to step 112 and the discharge rate is reduced by changing the position of the hopper's gate for decreasing the seed discharge rate. If at step 110 it is determined that the discharge rate is less than the predetermined set point, the program proceeds to step 114 and increases the discharge gate opening to increase the seed discharge rate so as to match the predetermined set point. The program then proceeds to step 116 to determine if the seed discharging hopper is empty. If at step 116 it is determined that the seed discharge hopper is not empty, the program returns to step 102 and to again determine the seed discharge rate set point. This cycle continues until the program determines at step 116 that the seed discharging hopper is empty, whereupon the program proceeds to step 118 and opens the hopper discharge gate to the full open position and then closes the hopper gate in preparation for a re-filling of the hopper with a new batch of seeds. The seed discharge rate control program then ends at step 120.

Referring to FIG. 14b, there is shown a series of operations carried out under the control of the controller 80 of the multi-flow bulk weighing system 10 of the present invention for the discharge of seed either sequentially from plural hoppers or the simultaneous discharge of seed from two or more hoppers. The multi-function program starts at step 130 and proceeds to step 132 for receiving a seed discharge request and the seed discharge mode parameters entered in the master controller 80 by an operator. The program then proceeds to step 134 and determines if an entered request is for the continuous discharge mode in a sequential manner from plural hoppers or for the simultaneous discharge from two or more hoppers to provide a blend of different types of seeds.

If a request for seed blending is entered in master controller 80 by an operator, the program proceeds to step 138 and, using the entered discharge mode parameters, calculates a corresponding discharge gate set point for each of the hoppers involved in the simultaneous multi-hopper discharge of seed from plural hoppers. The program then proceeds to step 160 and provides the calculated set points and start commands for each of the hoppers involved in the multi-hopper simultaneous seed discharge operation. Upon receipt of a start command, hoppers “A” and “B” simultaneously start discharging seed at steps 162 and 163. Upon determination by the master controller 80 that hoppers “A” and “B” have each discharged the required amount of seed, the discharge gate of hopper “A” is closed at step 164 and the discharge gate of hopper “B” is closed at step 168. The program in master controller 80 then confirms that seed discharge is complete from hoppers “A” and “B” at step 166 and proceeds to step 156 and then to step 158 for terminating the operation of simultaneous seed discharge from hoppers “A” and “B”.

If at step 134 master controller 80 determines that the requested mode of operation is the continuous discharge of seed sequentially from plural hoppers, the program proceeds to step 136 and calculates the discharge set point for each of the plural hoppers involved in the sequential discharge of seed based upon the operating parameters input by an operator to the master controller. The program then proceeds to step 140 and queries each of the hoppers to determine which hopper is online and not currently being used. The program then opens the discharge gate of hopper “A” at 142 and allows for the discharge of seed from hopper “A” until it is empty, and the program then closes the gate of hopper “A” at step 148. The program then initiates discharge from hopper “B” at step 144 which continues until the program determines that hopper “B” is empty at step 150 and closes its discharge gate at step 150. If additional hoppers are involved with the sequential discharge of seed, the program then proceeds to step 146 to determine which additional hopper, or hoppers, contains seed which is then discharged in sequence. Following discharge of seed from all of the hoppers in the system, the program proceeds to step 152 to confirm that the full amount of requested seed has been discharged by weighing the discharged seed. If it is determined at step 154 that the total amount of seed discharged from the various hoppers is not yet complete, the program returns to step 136 and calculates the discharge set points for additional hoppers based upon the discharge mode parameters entered by the operator. Once at step 154 it is determined that the full amount of seed has been discharged from all of the sequentially discharging hoppers, the program proceeds to step 156 and then to step 158 for ending the sequential discharge of seed operation from plural hoppers.

While particular embodiments of the present invention have been shown and described, it will be obvious to those skilled in the relevant arts that changes and modifications may be made without departing from the invention in its broader aspects. Therefore, the aim in the appended claims is to cover all such changes and modifications that fall within the true spirit and scope of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. Apparatus for controlling the discharge of bulk material from plural hoppers, said apparatus comprising:
plural gates each attached to a lower portion of and disposed over an aperture in a respective hopper and movable in a substantially continuous manner between a closed position and a full open position;
plural scales attached to each of said hoppers for weighing each of said hoppers and the bulk material within the hopper and measuring the rate of seed discharge of the bulk material from each of the hoppers; and
a controller coupled to each of said gates and to each of said scales for positioning each gate in a respective hopper in a designated position so as to provide a predetermined discharge rate of the bulk material.

2. The apparatus of claim 1, wherein said controller sequentially positions the gate of each hopper in an open position and the gates of the remaining hoppers in the closed position to allow one of the hoppers to discharge bulk material and the remaining hoppers to be re-filled for providing continuous, non-stop bulk material discharge from the hoppers.

3. The apparatus of claim 1, wherein each hopper contains a different type of bulk material and said controller positions each hopper gate at an individual designated position to provide a respective predetermined discharge rate of the bulk material from each hopper to provide a selected blend of bulk material from the hoppers.

4. The apparatus of claim 1 further comprising plural air cylinders each coupled to a respective gate of a hopper and further coupled to said controller for controlling the open/closed position of its respective gate.

5. The apparatus of claim 4, wherein each of said air cylinders is capable of controlling the position of its associated gate to an accuracy of +/−1% of the stroke of the air cylinder or to within +/−0.001 inch.

6. The apparatus of claim 1, wherein the bulk material is in the form of crop seeds.

7. The apparatus of claim 6, wherein each of said hoppers contains a different type of seed

8. The apparatus of claim 6 further comprising a seed treatment arrangement coupled to said controller and adapted to receive seeds discharged from the hoppers for applying a treatment substance to the seeds in a predetermined amount, wherein said controller controls the discharge rate of the seeds in accordance with said predetermined amount.

9. The apparatus of claim 8, wherein said treatment substance is in liquid or liquid-like form.

10. The apparatus of claim 9, wherein said treatment substance is sprayed on the seeds.
